(19) United States
(12) Patent Application Publication
(10) Pub. No.: US 2023/0118922 A1
(43) Pub. Date: Apr. 20, 2023

(54) SYSTEMS AND METHODS OF WIRELESS COMMUNICATION USING ARTIFICIAL INTELLIGENCE TO OVERCOME SKIP ZONES

(71) Applicant: GBT Technologies Inc., Santa Monica, CA (US)

(72) Inventors: Danny Rittman, San Diego, CA (US); Mo Jacob, Beverly Hills, CA (US)

(21) Appl. No.: 17/686,461

(22) Filed: Mar. 4, 2022

Related U.S. Application Data
(60) Provisional application No. 63/257,199, filed on Oct. 19, 2021.

(51) Int. Cl. H04B 7/155; H04B 7/208; H04B 7/185; H04B 7/22

(52) U.S. Cl. CPC H04B 7/15528; H04B 7/208; H04B 7/18543; H04B 7/22

(57) ABSTRACT

Wireless communication systems and methods are provided that include at least one base transmitter unit, at least one repeater unit, at least one receiver, and an artificial intelligence unit. The base transmitter unit is configured to transmit a data signal. The repeater unit is in communication with the transmitter and is configured to transmit the data signal via sky wave propagation. The receiver is in communication with the transmitter and the repeater and is configured to receive the data signal. The artificial intelligence unit monitors ionospheric conditions in the area and controls the data signal, making adjustments so the data signal overcomes skip zones. The adjustments may include automatically adjusting the power and position of the antenna array to re-route the data signal and/or dynamically changing the frequency of the data signal.

### CROSS-REFERENCE TO RELATED APPLICATION

This application is a non-provisional of and claims priority to U.S. Patent Application Ser. No. 63/257,199, filed Oct. 19, 2021, which is hereby incorporated by reference herein in its entirety.

### FIELD

The present disclosure relates to wireless communication systems and methods that overcome skip zones. The present disclosure relates to AI-based communication systems that learn about ionospheric conditions and make modifications so transmitted data signals overcome skip zones.

### BACKGROUND

High frequency (HF) radio propagation is the basis of wireless communication as radio signals are transmitted between a transmitter and a receiver. The ionosphere is the layer of the Earth's atmosphere that contains a high concentration of ions and free electrons and is therefore able to reflect radio waves. The ionosphere is located above the mesosphere and extends from about 50 to 600 miles above the Earth's surface.

Refractions from the ionosphere and from water and land on the Earth's surface create multiple instances of the same signal to be received. An HF radio signal may pass many hops between the ionosphere and the ground to cover the required distance for communication. Because of skip zones, which are the areas that the transmission crosses over, a signal may not reach its destination.

Accordingly, there is a need for improved wireless communication systems and methods that overcome skip zones. There is also a need for a wireless communication system and method that utilizes artificial intelligence (AI) to automatically learn about ionosphere conditions and make modifications so transmitted data signals overcome the skip zones.

### SUMMARY

The present disclosure, in its many embodiments, alleviates to a great extent the disadvantages and problems associated with wireless communication systems and methods by providing a novel AI-based system and method that monitors ionospheric conditions in the area of the data signal being transmitted and makes adjustments so that the signal overcomes skip zones. Advantageously, the AI-controlled HF radio wireless communication systems and methods described herein provide coverage at all times.

Exemplary embodiments include a base unit and mobile and repeater units that serve as wireless communication nodes for transmitting a data signal that is sent by skywave propagation. The HF radio data transmitted can be of audio, video and digital data and is reflected by the ionosphere back to earth. The data signal travels between base, mobile and repeater units to the ionosphere to earth and back until reaching its destination.

An AI unit continuously checks the ionospheric conditions along the data transmissions and automatically re-routes the HF transmissions to the appropriate base unit, mobile unit or repeater unit to overcome skip zones. The AI algorithms control Near Vertical Incidence Skywave (NVIS) technique, automatically adjusting the angle and power of antenna arrays to accommodate ionospheric changes. The end result is a continuous, clear, and reliable HF radio communication at all times of day, over all terrain types, and in all seasons and weather conditions.

In exemplary embodiments, the AI unit dynamically selects the best antenna from an antenna array and may automatically change its position and power to accommodate a reliable and clear signal. The unit dynamically creates a path between the network's devices to take the fewest hops to reduce latency time and to reduce reflection loss and distortion that can occur when a signal is bounced off the ionosphere or other objects.

An exemplary embodiment of a wireless communication system comprises at least one base unit, at least one transmitter (which may be part of the base unit), at least one repeater unit, at least one receiver, and an artificial intelligence unit. The transmitter and the receiver may be located together in a transceiver. The base unit may be a transmitter, or the transmitter may be in communication with the base unit and be configured to transmit a data signal. The repeater unit is in communication with the transmitter (and/or the base unit) and is configured to transmit the data signal in an area via skywave propagation. Exemplary embodiments comprise a plurality of repeater units placed in multiple locations to ensure continuous communications. The receiver is in communication with the transmitter and is configured to receive the data signal. The artificial intelligence unit monitors ionospheric conditions in the area and makes an adjustment such that the data signal overcomes skip zones.

In exemplary embodiments, the wireless communication system further comprises at least one antenna array. The adjustment may include automatically adjusting the power and position of the antenna array to re-route the data signal and/or dynamically changing the frequency of the data signal. The data signal may be a radio signal, and the data in the data signal may be one or more of audio data, digital data, or video data. In exemplary embodiments, the data signal bounces off the ionosphere and the ground multiple times before being received by the receiver. The artificial intelligence unit may encrypt and decrypt the data signal.

Exemplary methods of wireless communication comprise transmitting a data signal in an area via skywave propagation, monitoring ionospheric conditions via artificial intelligence, controlling the data signal via artificial intelligence, and receiving the data signal. The data is transmitted so it is reflected or refracted by the ionosphere at a reflection or refraction point. The artificial intelligence controls the data signal so the signal overcomes skip zones. The artificial intelligence control may include automatically adjusting the power and position of an antenna array to re-route the data signal and/or dynamically changing the frequency of the data signal. The monitoring and controlling may also comprise multiplexing instructions data with informational data.

Exemplary methods further comprise determining the path of the data signal via artificial intelligence to minimize hops for faster performance. In exemplary embodiments, when the data signal is reflected or refracted by the ionosphere at the reflection or refraction point the data signal begins to travel back to the surface of the earth. The methods may further comprise controlling near vertical incidence skywave technique. Exemplary methods further comprise encrypting and decrypting the data signal. The data signal may be a radio signal, and the data in the data signal may be one or more of audio data, digital data, or video data.

Accordingly, it is seen that systems and methods of wireless communication using artificial intelligence to overcome skip zones are provided. These and other features of disclosed embodiments will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a schematic of an exemplary embodiment of a wireless communication system and method in accordance with the present disclosure;

FIG. 2 is a schematic of an exemplary embodiment of a wireless communication system and method in accordance with the present disclosure;

FIG. 3 is a schematic of an exemplary embodiment of a wireless communication system and method in accordance with the present disclosure;

FIG. 4 is a block diagram of an exemplary embodiment of a wireless communication system and method in accordance with the present disclosure;

FIG. 5 is a schematic of an exemplary embodiment of a wireless communication system and method in accordance with the present disclosure;

FIG. 6 is a schematic of an exemplary embodiment of a wireless communication system and method showing a hub concept in accordance with the present disclosure;

FIG. 7 is a schematic of an exemplary embodiment of a wireless communication system and method showing a hub concept in accordance with the present disclosure;

FIG. 8 is a schematic of an exemplary embodiment of a wireless communication system and method showing a hub concept in accordance with the present disclosure;

FIG. 9 is a process flow diagram of an exemplary embodiment of a wireless communication system and method showing an exemplary AI unit in accordance with the present disclosure;

FIG. 10 is a process flow diagram of an exemplary embodiment of a wireless communication system and method in accordance with the present disclosure; and

FIG. 11 is an ionospheric map showing an exemplary frequency change sample in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure.

As used herein, the “present disclosure” refers to any one of the embodiments described herein, and any equivalents. Furthermore, reference to various aspects of the disclosure throughout this document does not mean that all claimed embodiments or methods must include the referenced aspects. Reference to materials, configurations, directions, and other parameters should be considered as representative and illustrative of the capabilities of exemplary embodiments, and embodiments can operate with a wide variety of such parameters. It should be noted that the figures do not show every piece of equipment, nor the materials, configurations, and directions of the various circuits and communications systems.

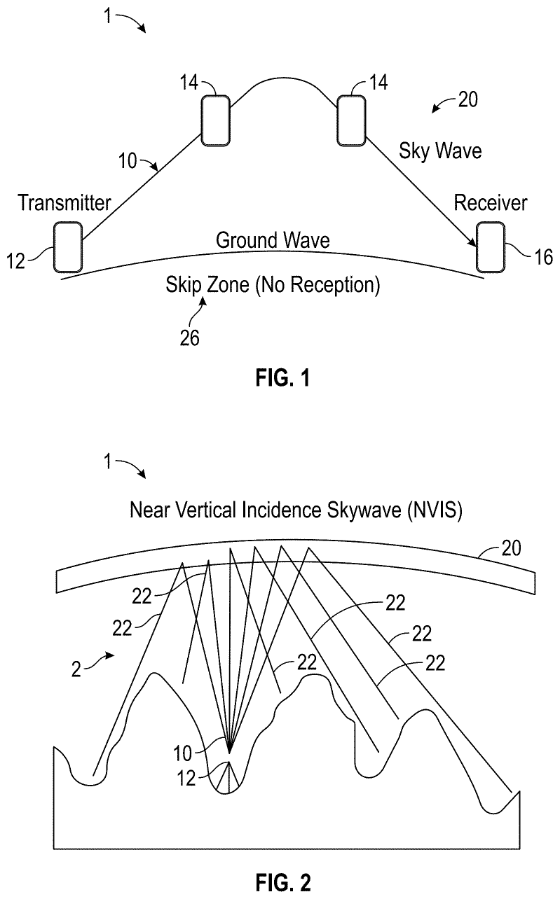

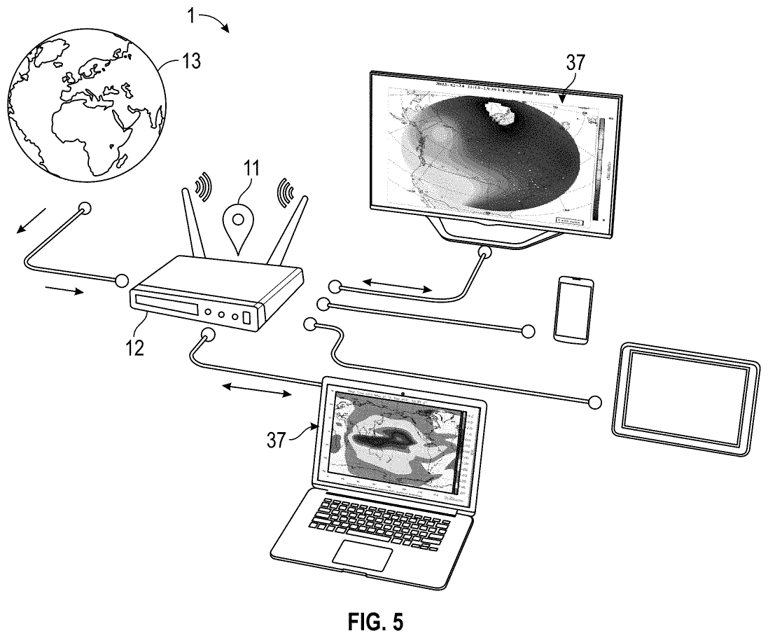

An exemplary embodiment of a wireless communication system 1 is shown in FIGS. 1-5, which is comprised of a wireless communication device, e.g., a base transmitter unit 12, and repeater units 14 for transmitting a high frequency (HF) data signal 10 as an electromagnetic wave. Exemplary communication systems 1 use skywave propagation, e.g., radio communication to provide a low latency high bandwidth communication pathway for data signals 10, e.g., voice, digital data and/or video, between a remotely located transmitter 12 and a receiver station 16. Alternatively, one or more transceivers 44 could be used instead of transmitters and receivers. Both base units and mobile units may function as transmitters, receiver, and/or repeaters, with base units being stationary and mobile units being portable and locatable anywhere on Earth.

In exemplary embodiments, the data signal includes multiplexed instructions and communicated information, and an AI unit multiplexes the instructions data with the informational data. The data signals 10 transmitted by skywave propagation are received by receiver 16. The system 1 also includes an antenna array 20 consisting of one or more antenna types. The repeater units 14 may be placed in various locations to ensure continuous communication between all the system's units.

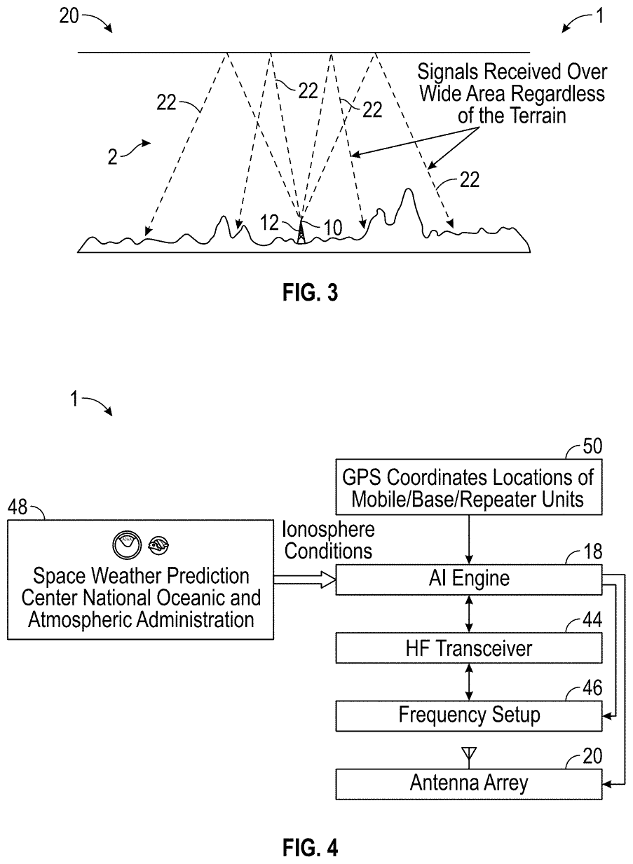

The data signals 10 transmitted from the wireless communication device 12 are reflected or refracted by the ionosphere 20. The reflection or refraction point is a location at which the data signal 10 is reflected or refracted by the ionosphere of the earth so that the electromagnetic wave begins to travel back to the surface of the earth. Due to reflection ro refraction from the ionosphere 20, several different transmissions of the same data signal 10 may be received. Each of the different transmissions may have taken a different path to get from the transmitter 12 (base unit or mobile unit) to the receiver 16 with different paths including different numbers of hops between the ionosphere 20 and the ground. Typically, for a skywave propagation communication pathway, multiple hops 22 are required; that is, the radio signal 10 is reflected or bounced off the ionosphere and ground multiple times before it reaches the receiver station 16. As best seen in FIGS. 2 and 3, exemplary systems 1 advantageously support Near Vertical Incidence Skywave (NVIS) propagation 2. As discussed in more detail herein. NVIS is useful in all terrains, especially for mountainous or rough terrain where radio signals are blocked.

In exemplary embodiments, the wireless communication system 1 is controlled by an AI unit 18. For example, the data transmissions 10 are sent from a mobile transmitter unit, base transmitter unit, or repeater unit 14 that are controlled by AI processes. The AI unit 18 receives GPS data 11 including as the coordinates 50 of the units in the system and traces the transmitted and reflected signals. It systematically monitors hops, and signal pathways between all units, eliminating redundancies and ensuring reliable, clear, and stable data communication. To optimize communication, the AI unit 18 may determine the smallest network device's setup with the fewest hops for faster performance.

The AI unit 18 also monitors the atmospheric/ionospheric conditions 30 and the geographical coordinates of the other units in the system. More particularly, the AI unit 18 receives ionosphere information 24/7 and controls the HF frequencies and antenna type selection, its power (db) and its angle to achieve reliable, continuous communications at all times. HF radio signals are highly affected by weather/terrain conditions, day/night and seasons, and therefore AI unit 18 may provide frequency setup for the data transmission according to time of day, weather conditions and terrain.

In exemplary embodiments, the AI unit 18 may receive weather information from a weather center 48 such as the National Oceanic and Atmospheric Administration. The AI unit 18 constantly monitors these conditions and automatically adjusts the necessary frequency for optimal and reliable communication, dynamically changing to the best frequency for full coverage and clarity. In some instances, it may be desired to use the data signal 10 that has travelled to constantly scan the weather, terrain and day/night, seasons conditions, and automatically adjust the network's units' frequency to achieve a reliable, clear transmission.

As best seen in FIG. 5, in exemplary embodiments the base unit 12 may include GPS information 11 to identify the locations of the units and have access to ionospheric map data 13. Exemplary base units are static and connected to the internet to receive the ionospheric information 13 24/7 from ionospheric maps on government websites. The GPS data 11 (including the coordinates 50 of all mobile units in the network) is set in the base units and mobile units, both of which also may function as repeaters. It should be noted that the mobile units can find their location without the onboard GPS unit. If GPS service is not available, the mobile units can triangulate their location with other units. In this way the system always knows its mobile units' geographical locations.

In exemplary embodiments, the ionospheric data is fed into the AI unit 18. The processing of the GPS data is done with the AI analytics, together with the data of the ionospheric map to decide how to route the signals between units. Thus, a signal from a mobile unit in Atlanta that wants to communicate with a mobile unit in Oregon may pass through Canada, New York, and Texas just to avoid skip zones and establish communication.

In exemplary embodiments, the AI unit 18 controls the systems' antennas 24. It dynamically adjusts the antennas' position and/or power according to ionospheric conditions to achieve the best performance. More particularly, the AI unit 18 changes the antennas' positions and transmitting power to achieve the highest communication performance. The AI unit 18 also may control an electronic circuit that dynamically makes antennas' position/power adjustments to achieve the best performance. In addition, the AI unit controls electronic servos circuitries to select from different types of antennas according to the mentioned conditions. The AI unit also may select from the system antennas 24 array the best antenna type to achieve the best performance.

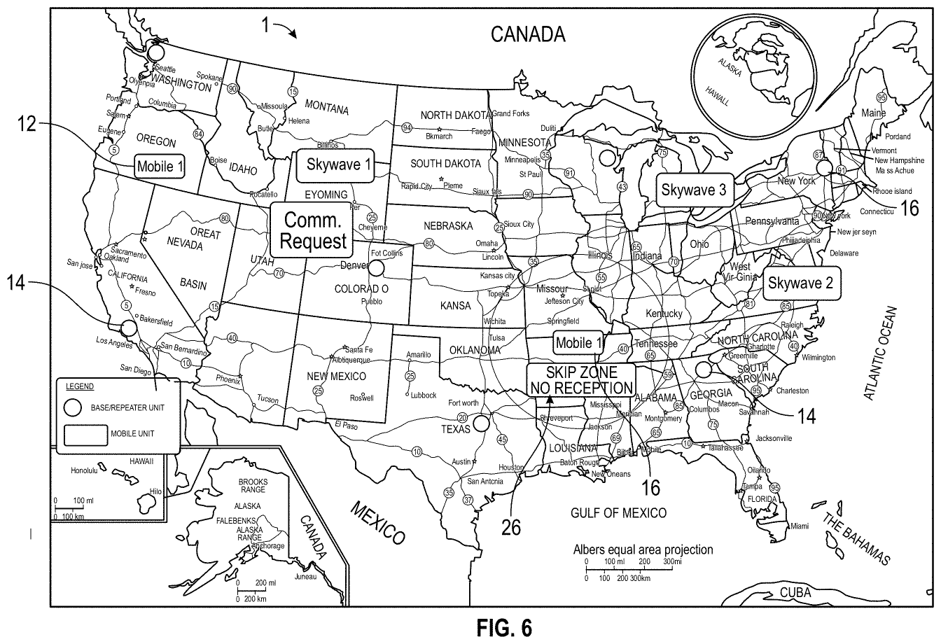

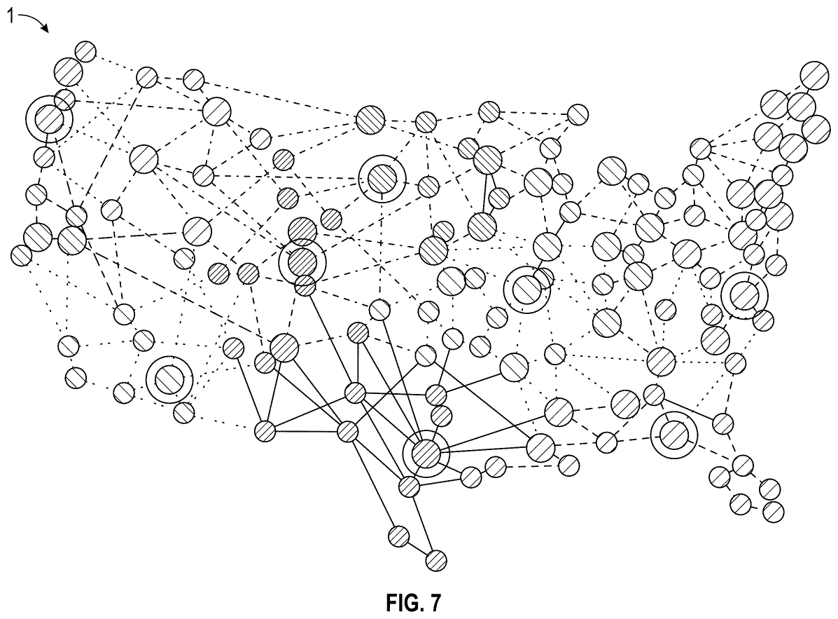

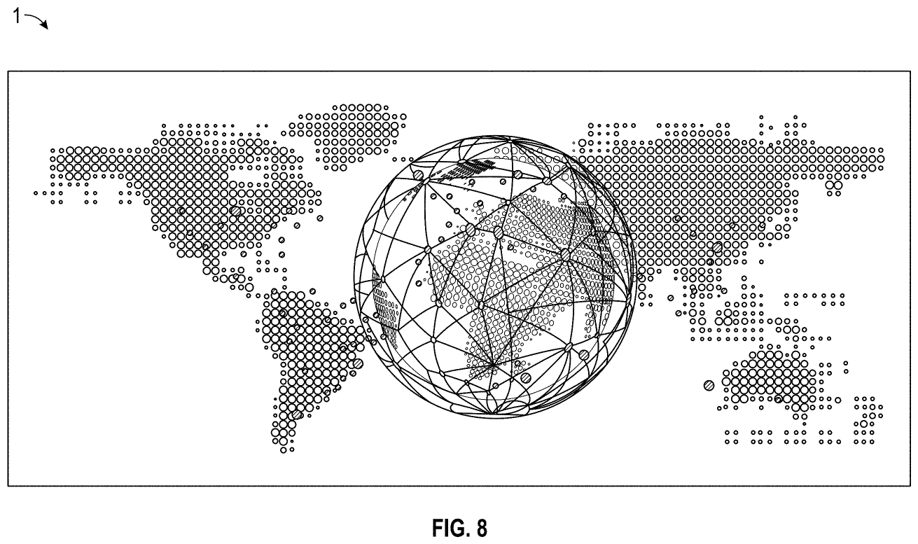

As illustrated in FIGS. 6, 7 and 8, system 1 can provide skywave hub coverage across any country and throughout the world. The system 1 performs mathematical processes to ensure the smallest number of hops and re-route the data signal 10 through selected units to overcome skip zones 26, in which the signal wouldn't be able to reach its destination. In this instance, MOBILE 1 and MOBILE 2 units cannot communicate due to a skip zone 26. The AI unit 18 re-routes the signal 10 through a repeater 14 in Atlanta, Ga. and from there to another repeater 14 in Albany, N.Y. and from there to MOBILE 2.

In another example, if a base unit transmitter 12 in Los Angeles is interested to establish communication with repeater 14 in Albany, N.Y., the AI unit 18 may re-route the signal through Phoenix, Ariz. or any other further or closer units 14, to overcome skip zones 26. The system analogy can be compared to air traffic for which a direct flight is not available but only through layover airports. Although the data signal 10 may travel a longer pathway, the latency effect for the user will be minimal (Milliseconds) which is negligible. The focus is on establishing clear and reliable communication at all times and in all conditions.

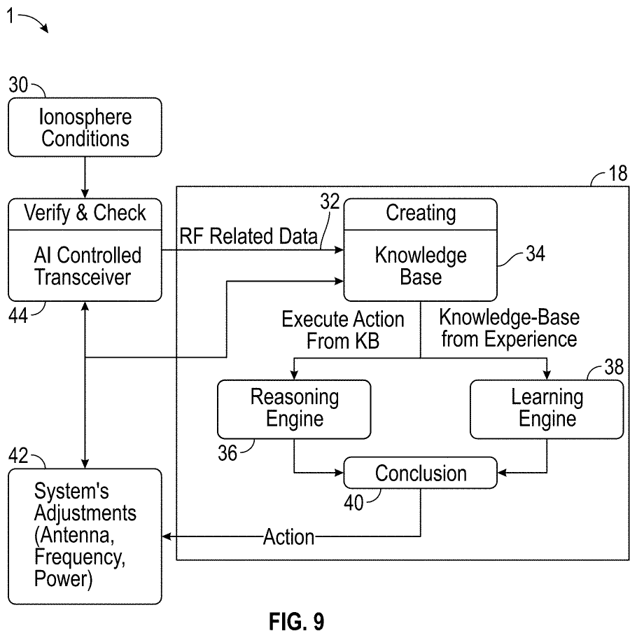

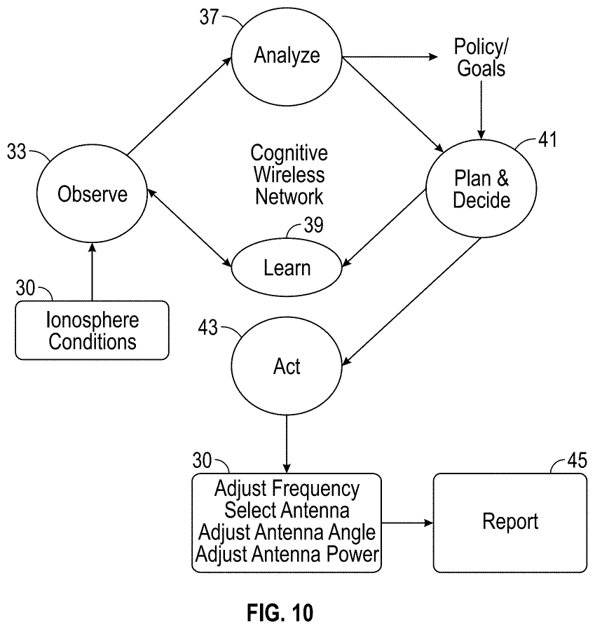

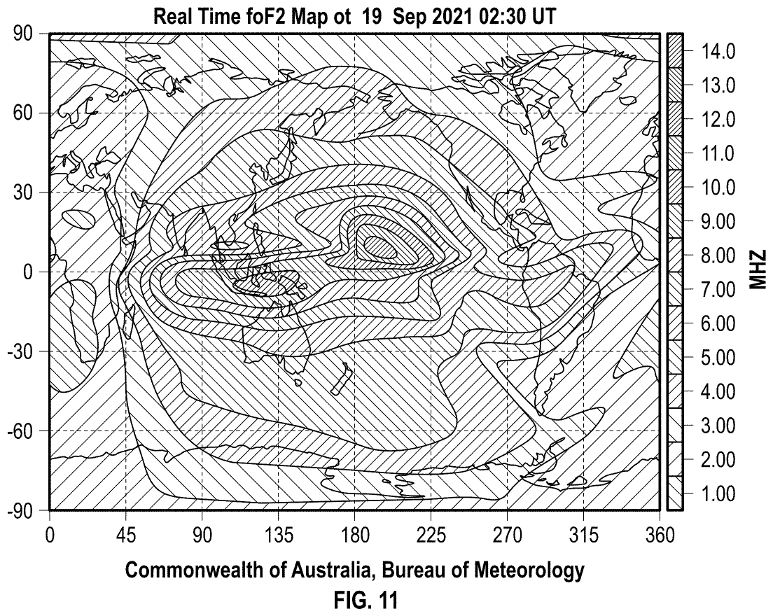

Referring to FIGS. 9 and 10, to effectively control the system 1, the AI unit 18 processes RF related data 32, observes 33 ionospheric conditions 30 and other data, and uses the data to create a knowledge base 34. FIG. 9 illustrates the system's AI radio control system, and FIG. 10 illustrates the system's AI cognitive wireless network. The AI unit 18 may contain a reasoning engine 36 so it can execute actions from its knowledge base and a learning engine 38 so it can learn 39 from its experience. The learning and reasoning, as well as analysis 37 lead the AI unit to plan and decide 41 and reach conclusions 40 about how to act 43 to control the system. These actions can include system adjustments 42, as described above, including to the antennas 20 and/or frequency and power of the data signal. The adjustments 42 and other control instructions may be sent to transmitter 12, transceiver 44, and/or other units of the system. In addition, the system may generate reports 45 detailing its analysis and actions.

As mentioned above, exemplary systems support Near Vertical incidence Skywave (NVIS) propagation 2. The NVIS propagation method is particularly useful where radio communication coverage is required in regions where the ground is mountainous or rough because other modes relying on more direct coverage have significant areas where the radio signal is masked or shadowed. The system utilizes NVIS propagation with a high signal angle of elevation that is not shielded by the terrain.

The AI unit 18 controls the angle and dynamically changes the signal angle according to terrain and skywave conditions. NVIS propagation typically requires a high angle or near vertical signal to be transmitted towards the ionosphere. This should be at a frequency that is below the critical frequency, i.e., the maximum frequency at which a vertically incident signal is “reflected” by the ionosphere. The AI unit 18 ensures that the frequency is always just below the critical frequency for the ionospheric layer or region that is to be used. The AI unit 18 also may select from the system antenna array the best antenna type to implement an NVIS method.

In exemplary embodiments, the AI unit 18 provides an error-correction protocol and encryption/decryption mechanism for security and reliability. It may encrypt and decrypt the data for security. The system processes the transmitted data signal 10 from the first data transmission device to a second destination device. In the event of any errors, the system activates the AI controlled error-correcting protocol to ensure correct data.

Disclosed systems 1 and techniques can be used in wide variety of situations or industries where time and bandwidth are of concern. For example, the system can be used to perform global computer networks control and/or military communication applications. The system 1 can transmit digital data, voice and video signals, which can be used to provide high bandwidth internet services to remote locations. Disclosed systems and techniques can, for example, be adapted to be used for remote emergency systems and telemedicine. Medical services can be provided via radio to assist remote population.

In operation, base transmitter unit 12 and repeater units 14 transmit an HF data signal 10 as an electromagnetic wave using skywave propagation. The data signals 10 are reflected or refracted by the ionosphere 20. There may be a number of transmissions 10, and each of the different transmissions may take a different path, including different numbers of hops between the ionosphere 20 and the ground. The AI unit 18 monitors the hops 22 and ensures the smallest number of hops 22, possibly re-routing the data signal 10 through selected units to overcome skip zones 26.

The AI unit may re-route a transmitted data signal 10 to any of the network's components to overcome skip zones 26 and reach the destination. For example, if a transmission is sent from a mobile unit #1, aiming to communicate with mobile unit #2 which is in a skip zone, the AI unit 18 may re-route the signal through selected base units #3 and #4, and repeaters #5 and #6, to reach mobile unit #2. This is done similarly to a flight connection hub operation.

The AI unit 18 also monitors the atmospheric conditions and the geographical coordinates of the other units in the system 1 and automatically adjusts the necessary frequency for optimal and reliable communication, dynamically changing to the best frequency for full coverage and clarity. In addition, the AI unit 18 controls the systems' antennas 24, dynamically adjusting their position and/or power according to ionospheric conditions to achieve the best communication performance. The AI unit also may select from the system antennas 24 array the best antenna type to achieve the best performance. A satellite image sample for HF frequencies due to day/time changes is illustrated in FIG. 11. The AI unit is monitors 24/7 these changes 24/7 and automatically adjusts the frequencies, antenna's position, and power. The data signals 10 ultimately are received by receiver 16.

Thus, it is seen that systems and methods of wireless communication that overcome skip zones are provided. It should be understood that any of the foregoing configurations and specialized components or connections may be used interchangeably with any of the systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the present disclosure.

What is claimed is:

1. A wireless communication system comprising:
at least one base transmitter unit being configured to transmit a data signal;
at least one repeater unit in communication with the at least one base transmitter unit, the at least one repeater unit being configured to transmit the data signal in an area via skywave propagation;
at least one receiver in communication with the at least one transmitter and the at least one repeater, the receiver being configured to receive the data signal; and
an artificial intelligence unit monitoring ionospheric conditions in the area and making an adjustment such that the data signal overcomes skip zones.

2. The wireless communication system of claim 1 further comprising at least one antenna array.

3. The wireless communication system of claim 2 wherein the adjustment comprises automatically adjusting power and position of the antenna array to re-route the data signal.

4. The wireless communication system of claim 1 wherein the adjustment comprises dynamically changing frequency of the data signal.

5. The wireless communication system of claim 1 further comprising at least one transceiver.

6. The wireless communication system of claim 1 wherein the at least one repeater unit comprises a plurality of repeater units placed in multiple locations to ensure continuous communications.

7. The wireless communication system of claim 1 wherein the data signal is a radio signal.

8. The wireless communication system of claim 1 wherein the data signal bounces off the ionosphere and the ground multiple times before being received by the receiver.

9. The wireless communication system of claim 1 wherein the data in the data signal is one or more of: audio, digital, or video.

10. The wireless communication system of claim 1 wherein the artificial intelligence unit encrypts and decrypts the data signal.

11. A method of wireless communication, comprising:
transmitting a data signal in an area via skywave propagation such that the data signal is reflected or refracted by the ionosphere at a reflection or refraction point;
monitoring ionospheric conditions in the area via artificial intelligence;
controlling the data signal via artificial intelligence such that the data signal overcomes skip zones; and
receiving the data signal.

12. The method of claim 11 wherein the controlling comprises automatically adjusting power and position of an antenna array to re-route the data signal.

13. The method of claim 11 wherein the controlling comprises dynamically changing frequency of the data signal.

14. The method of claim 11 further comprising determining a path of the data signal via artificial intelligence to minimize hops for faster performance.

15. The method of claim 12 further comprising controlling near vertical incidence skywave technique.

16. The method of claim 11 wherein when the data signal is reflected or refracted by the ionosphere at the reflection or refraction point the data signal begins to travel back to the surface of the earth.

17. The method of claim 11 wherein the monitoring and controlling comprises multiplexing instructions data with informational data.

18. The method of claim 11 further comprising encrypting and decrypting the data signal.

19. The method of claim 11 wherein the data signal is a radio signal.

20. The method of claim 11 wherein the data in the data signal is one or more of: audio, digital, or video.
